(19) United States
(12) Patent Application Publication
(10) Pub. No.: US 2012/0275260 A1
(43) Pub. Date: Nov. 1, 2012

(54) MIXING APPARATUS

(75) Inventors: Johannes Haas, Wien (AT); Johann Haas, Klosterneuburg (AT); Josef Haas, Wien (AT); Stefan Jiraschek, Koenigsbrunn (AT); Norbert Drapela, Langenzersdorf (AT); Markus Breyer, Wullersdorf (AT); Karl Tiefenbacher, Wien (AT)

(73) Assignee: HAAS FOOD EQUIPMENT GMBH, WIEN (AT)

(21) Appl. No.: 13/516,013

(22) PCT Filed: Dec. 14, 2010
(86) PCT No.: PCT/EP2010/007612

§ 371 Date: Jun. 14, 2012

(30) Foreign Application Priority Data
Dec. 14, 2009 (AT) A 1971/2009

(51) Int. Cl. B01F 7/16

(52) U.S. Cl. 366/314

(57) ABSTRACT

A mixing device has a frame, a cylindrical mixing container that is open toward the top, and a single-shaft agitator. A vertical agitator shaft extends into the mixing container from beneath. The agitator is an agitator without a stator and includes a rotor body arranged just above the container bottom in the mixing container. The rotor body is surrounded by a ring-shaped clearance between the rotor body and the container wall. Above the base plate fastened to the agitator shaft, the rotor body is provided with an inner clearance above the agitator shaft, mixing blades vertically arranged about the clearance, and flow channels arranged between the blades. The channels are delimited toward the top by a cover plate that is connected to the upper edges of the mixing blades. The cover plate is formed with a void arranged in the center and above the inner clearance.

The invention relates to a mixing apparatus having a stand which supports an upwardly open, cylindrical mixing container, which is disposed in upright position in the upper part of the mixing apparatus, and a single-shaft agitator, which is disposed in the lower part of the mixing apparatus and has a vertically disposed agitator shaft to which an agitating tool, which is disposed in the mixing container just above the container bottom and is configured as a rotor body, is fastened.

### FIELD OF THE INVENTION

In such mixing apparatuses are produced large quantities of shapeless masses, which consist mainly of water and flour, generally have a liquid to pasty consistency and from which edible, baked products, or baked products not intended for consumption, are subsequently produced in a baking process.

Shapeless masses of this kind are, for example, the liquid baking preparations which are used in the baking methods associated with wafer baking technology.

The liquid baking preparations consist mainly of water and a powdery principal component, generally wheat flour or a starch flour, or another cereal flour, or a mixture of different cereal or starch flours. The liquid baking preparations also contain yet other powdery or liquid ingredients, which respectively account for only a small proportion of the total quantity of the respective baking preparation and, in accordance with their respective consistency, are generally introduced into the mixing container of the mixing apparatus together with the liquid components of the baking preparation or together with the powdery components of the baking preparation.

The baked products produced from the liquid baking preparations can be edible baking products, such as are known, for example, from the soft wafers, the crispy-crunchy wafer cones for ice cream, or the crispy-crunchy wafer sheets of cream-filled wafer bars.

The baked products produced from the liquid baking preparations can also however be other products which are not in themselves intended for consumption, e.g. packaging articles such as packaging cups produced from a starch-containing baking preparation, or parts of a single-use dinner set, such as knives, forks, spoons or plates and cups, which are produced from such a baking preparation.

### PRIOR ART

In known mixing apparatuses for the production of liquid baking preparations there is provided an upwardly open, cylindrical mixing container, which is disposed in upright position in the upper part of the mixing apparatus and which receives the total quantity of the baking preparation to be produced and into which the liquid and powdery components of the baking preparation are fed from above. In the mixing container, just above the bottom, are disposed the stator and the rotor of a single-shaft agitator, which has a center axis concentric to the center axis of the container and the rotor of which is driven by a drive motor disposed below the mixing container in the lower part of the mixing apparatus. The agitator provides an outer, annular stator, which is provided with upright mixing blades and flow channels, arranged between the mixing blades, for the mix product. The annular stator is disposed just above the bottom of the mixing container and is rigidly connected to the bottom of the mixing container. The agitator further provides a rotor disposed in the interior of the stator, which rotor has a circular base plate, rigidly connected to the rotor drive shaft, and an annular outer ring, in which are disposed upright mixing blades and intervening flow channels for the mix product.

In the known mixing apparatuses, the cylindrical mixing container is tailored with its volume to the batch of baking preparation which is to be mixed therein. For different-sized batches there are therefore different-sized mixing apparatuses.

If the mixing containers of the known mixing apparatuses are only partially filled with the baking preparation to be produced, then, even though the predominant part of the total mass is well mixed, inadequately mixed mass residues can also be left in the middle of the mixing container or on the container wall, which must then be removed from the mixing container separately from the well-mixed main quantity of baking preparation.

### SUMMARY OF THE INVENTION

In order to achieve better mixing of the baking preparation even when the mixing container is only partially filled, according to the invention a new mixing apparatus, in which the agitator dispenses with a stator and now only provides a rotor provided with mixing blades, is proposed.

The new mixing apparatus has a stand which supports an upwardly open, cylindrical mixing container, which is disposed in upright position in the upper part of the mixing apparatus, and a single-shaft agitator. The single-shaft agitator has a vertically disposed agitator shaft to which an agitating tool, which is disposed in the mixing container just above the container bottom and is configured as a rotor body, is fastened.

In this mixing apparatus, the invention provides that the single-shaft agitator is configured as a statorless agitator, that the rotor body fastened to the agitator shaft is surrounded by an outer, annular free space, which is disposed between the rotor body and the cylindrical container wall of the mixing container, and that the rotor body has a base plate which is fastened to the agitator shaft and over which are provided an inner free space of the rotor body, disposed over the agitator shaft, mixing blades disposed in upright position around the inner free space, flow channels disposed between the mixing blades and running outward from the inner free space, and a cover plate bounding the flow channels in the upward direction and connected to the upper edges of the mixing blades, which cover plate contains a centrally arranged recess disposed above the inner free space of the rotor body.

In the mixing apparatus according to the invention, the statorless agitator generates with its rotor body immersed in the mix product a large flow vortex. This extends away from the rotor body, through the annular free space surrounding this, outward to the cylindrical container wall of the mixing container, which container wall bounds the large flow vortex in the outward direction. The large flow vortex is formed by the water which is introduced as the first mix product component into the mixing container. The water introduced into the mixing container covers the stationary rotor body, which is then set in rotation and generates a large flow vortex in the water. The powdery mix product components which are introduced after the water, from above, into the mixing container meet the rotating flow vortex and are drawn into this and mixed there with the water.

The large flow vortex generated by the rotating rotor body extends in the mixing container upward from the rotor body. The height of the flow vortex depends on the size of the batch of mix product or baking preparation which is to be produced. The flow vortex can reach only up to half the height of the mixing container. If the total volume of the mixing container is used to produce the mix product, then the flow vortex in the mixing container extends upward to the maximum fill level height of the mixing container.

The inventive design of the mixing apparatus has a host of advantages for the construction and design of different-sized mixing apparatuses.

Compared with known mixing apparatuses in which the single-shaft agitator provides an annular stator which surrounds the rotor on the outer side and is rigidly connected to the bottom of the mixing container, the following advantages can be listed.

The annular stator which is rigidly connected to the bottom of the mixing container and constitutes a relatively complex and relatively expensive component is dispensed with. The number of components of the mixing apparatus is thus reduced to the extent of the stator.

Through the loss of the stator, in the cylindrical mixing container of the mixing apparatus a large amount of space becomes free around the rotor body for radial enlargement of the rotor body.

In the mixing apparatus according to the invention, it is possible to use a rotor body having a large outer diameter which can be significantly greater than the outer diameter of the annular stator body in a same-sized known mixing apparatus, the single-shaft agitator of which provides an annular stator which surrounds the rotor on the outer side.

The inventive design of the mixing apparatus allows the rotor body of the agitator, which rotor body is disposed in the cylindrical mixing container, to be significantly enlarged without having to take into account an annular stator body surrounding the rotor body on the outer side, which stator body, in the known agitators equipped with stator and rotor, must likewise not only itself be enlarged in accordance with the enlargement of the rotor body, but must also be accommodated as an enlarged, annular stator body between the outer side of the already enlarged rotor body and the container wall of the cylindrical mixing container.

According to a further feature of the invention, it can be provided that the rotor body is provided with mixing blades arranged in a star shape.

According to a further feature of the invention, it can be provided that the mixing blades are configured as curved mixing blades.

According to a further feature of the invention, it can be provided that the mixing blades are configured as radially running mixing blades.

According to a further feature of the invention, it can be provided that, in respect of the rotor body, the mixing blades arranged in a star shape protrude with their inner end portions into the inner free space of the rotor body.

According to a further feature of the invention, it can be provided that, in respect of the rotor body, the mixing blades arranged in a star shape protrude outward with their outer end portions over the outer edge of the cover plate and protrude into the outer, annular free space disposed between the rotor body and the cylindrical container wall of the mixing container.

According to a further feature of the invention, it can be provided that the rotor body is provided with additional mixing blades, which protrude outward over the outer edge of the cover plate and protrude into the outer, annular free space disposed between the rotor body and the cylindrical container wall of the mixing container.

According to a further feature of the invention, it can be provided that the additional mixing blades are configured in one piece with the mixing blades disposed between the base plate and the cover plate of the rotor body.

According to a further feature of the invention, it can be provided that the additional mixing blades have a lower portion, running parallel to the rotor rotational axis, and an upper portion, running obliquely to the rotor rotational axis.

According to a further feature of the invention, it can be provided that the additional mixing blades protrude downward over the base plate of the rotor body.

According to a further feature of the invention, it can be provided that, in the base plate of the rotor body, which base plate is fastened to the agitator shaft, two or more webs bounded by holes or apertures are provided in the region outwardly adjoining the agitator shaft.

In a further embodiment of the invention, it can be provided that in the mixing container, above the rotor body, is provided a free space in which there is disposed at least one impact element, which reaches from above into the mixing spout generated by the rotating rotor body and extending upward from the rotor body.

This embodiment of the mixing apparatus provides an impact element which is fixedly disposed in the mixing container, reaches from above into the mixing spout generated by the rotating rotor body and extending upward from the rotor body, and ensures a strong turbulence of the mixing spout.

In order to obtain a stronger turbulence of the mixing spout, in the mixing container, two or more impact elements can also be provided in the free space provided above the rotor body, which impact elements reach from above into the mixing spout generated by the rotating rotor body and extending upward from the rotor body.

According to a further feature of the invention, it can be provided that an impact element is fitted to a bridge disposed in the free space provided above the rotor body.

According to a further feature of the invention, it can be provided that the bridge supporting an impact element is fastened to two vertical rails, which are fitted to the inner side of the cylindrical container wall at two substantially diametrically opposing points.

According to a further feature of the invention, it can be provided that the bridge supporting an impact element is vertically adjustable along the two vertical rails.

This embodiment allows the position of the impact element in the mixing container to be adjusted in accordance with the height of the mixing spout generated in the mix product by the rotating rotor body. This configuration is of advantage when the mixing container is only partially filled. In this case, the mixing spout generated by the rotating rotor body does not extend upward from the rotor body to the maximum fill level height of the mixing container. The impact element can be displaced downward by vertical displacement of the bridge in the mixing container and can then be fixed to the mixing container in the region of the upper end of the mixing spout.

According to a further feature of the invention, it can be provided that the two vertical rails supporting a bridge provided with an impact element are fitted in a vertically displaceable manner to the container wall of the mixing container.

This configuration, too, is of advantage in respect of an only partially filled mixing container, because the bridge provided with an impact element can be adjusted in terms of its height position in the mixing container by displacement of the vertical rails to the height of the mixing spout generated by the rotating rotor body.

According to a further feature of the invention, just a single impact element can be disposed in a vertically adjustable manner in the free space provided above the rotor body.

According to the invention, the impact element can be fastened to a vertical rail fitted to the inner side of the cylindrical container wall of the mixing container.

According to the invention, the impact element can be disposed adjustably along the vertical rail.

According to the invention, the vertical rail supporting the impact element can be fitted in a vertically displaceable manner to the container wall of the mixing container.

According to the invention, it can further be provided that, in respect of the rotor body, the base plate and the cover plate have an outer diameter amounting to 45% to 55%, preferably 46.5% to 53%, of the inner diameter of the cylindrical mixing container.

According to the invention, it can further be provided that, in respect of the rotor body, the base plate and the cover plate have an outer diameter amounting to 40% to 88% of the inner diameter of the cylindrical mixing container.

According to the invention, it can further be provided that, in respect of the rotor body, the central recess disposed in the cover plate has an inner diameter amounting to 30% to 40%, preferably 33.5% to 39%, of the inner diameter of the cylindrical mixing container.

According to the invention, it can further be provided that, in respect of the rotor body, the central recess disposed in the cover plate has an inner diameter amounting to 11% to 66% of the inner diameter of the cylindrical mixing container.

According to the invention, it can further be provided that, in respect of the rotor body, the distance between the base plate and the cover plate amounts to between 1.7% and 15% of the inner diameter of the cylindrical mixing container.

The invention is explained in greater detail below on the basis of some illustrative embodiments.

### BRIEF DESCRIPTION OF THE DRAWINGS

FIG. 1 shows schematically a known mixing apparatus having a known agitator.

FIG. 2 shows schematically a new mixing apparatus having a new agitator.

FIG. 3 shows schematically a further new mixing apparatus having a new agitator.

FIGS. 4 to 7 show schematically mixing apparatuses having different-sized mixing containers.

FIG. 8 shows a mixing container of a new mixing apparatus having a new agitator.

FIG. 9 shows the lower part of a mixing apparatus having a new agitator.

FIG. 10 shows the lower part of a mixing apparatus having a new agitator.

FIG. 11 shows a rotor body from the side.

FIG. 12 shows the rotor body of FIG. 11 from above.

FIG. 13 shows a 3D representation of the rotor body of FIG. 11.

FIGS. 14 to 16 show schematically three embodiments of the new mixing apparatus.

FIG. 17 shows a further rotor body from the side.

FIG. 18 shows the rotor body of FIG. 17 from above.

FIG. 19 shows a 3D representation of the rotor body of FIG. 17.

FIG. 20 shows a further rotor body from the side.

FIG. 21 shows the rotor body of FIG. 20 in the lower part of a mixing container.

FIG. 22 shows the rotor body and the mixing container of FIG. 20 from above.

FIG. 23 shows a 3D representation of FIG. 21.

FIG. 24 shows a further rotor body from the side.

FIG. 25 shows the rotor body of FIG. 24 in the lower part of a mixing container.

FIG. 26 shows the rotor body and the mixing container of FIG. 25 from above.

FIG. 27 shows a 3D representation of FIG. 26.

FIG. 28 shows a further rotor body from the side.

FIG. 29 shows the rotor body of FIG. 28 in the lower part of a mixing container.

FIG. 30 shows the rotor body and the mixing container of FIG. 29 from above.

FIG. 31 shows a 3D representation of FIG. 30.

### KNOWN MIXING APPARATUS

FIG. 1 shows a known mixing apparatus. This has a stand 1, which stands on the floor. The stand 1 supports an upwardly open, cylindrical mixing container 2, which is disposed in upright position in the upper part of the mixing apparatus. A circular plate 3, fastened to the stand 1, forms the bottom of the mixing container 2. The stand 1 further supports a single-shaft agitator 4 disposed in the lower part of the mixing apparatus. The agitator 4 has a drive motor 5, which is fastened to the stand 1 and the vertically disposed drive shaft of which, as the agitator shaft 6, projects upward into the mixing container 2. The agitator 4 has two agitating tools disposed in the mixing container 2, a rotor body 7 fastened to the upper end of the agitator shaft 6, and an annular stator body 8, which surrounds said rotor body. The rotor body 7 is disposed just above the container bottom and the stator body 8 is rigidly connected to the container bottom.

### DESCRIPTION OF ILLUSTRATIVE EMBODIMENTS OF THE INVENTION

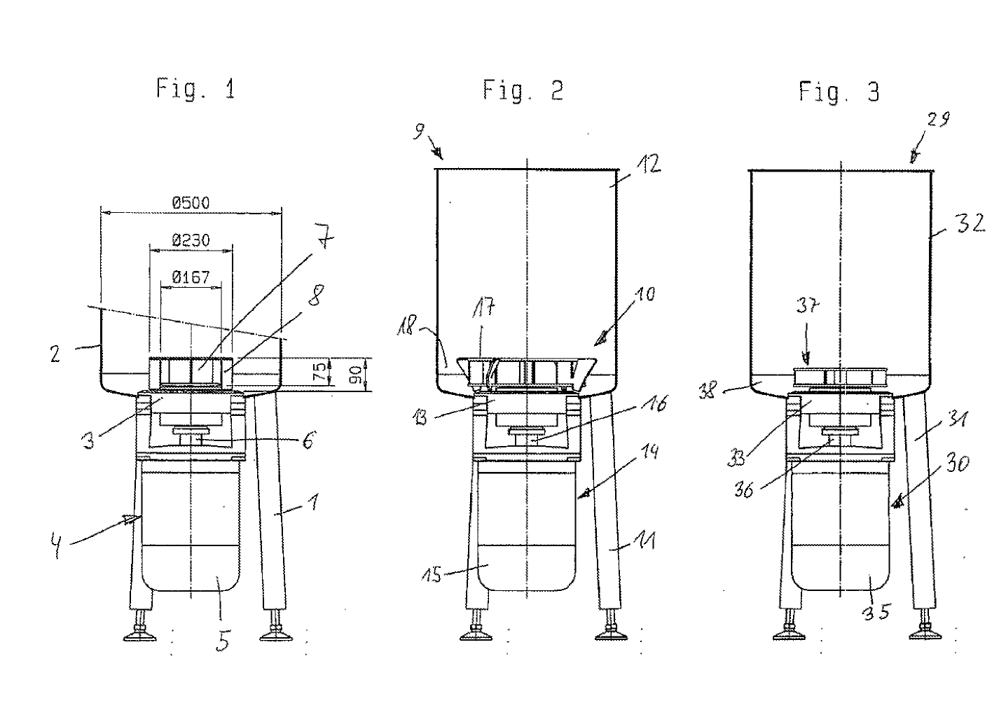

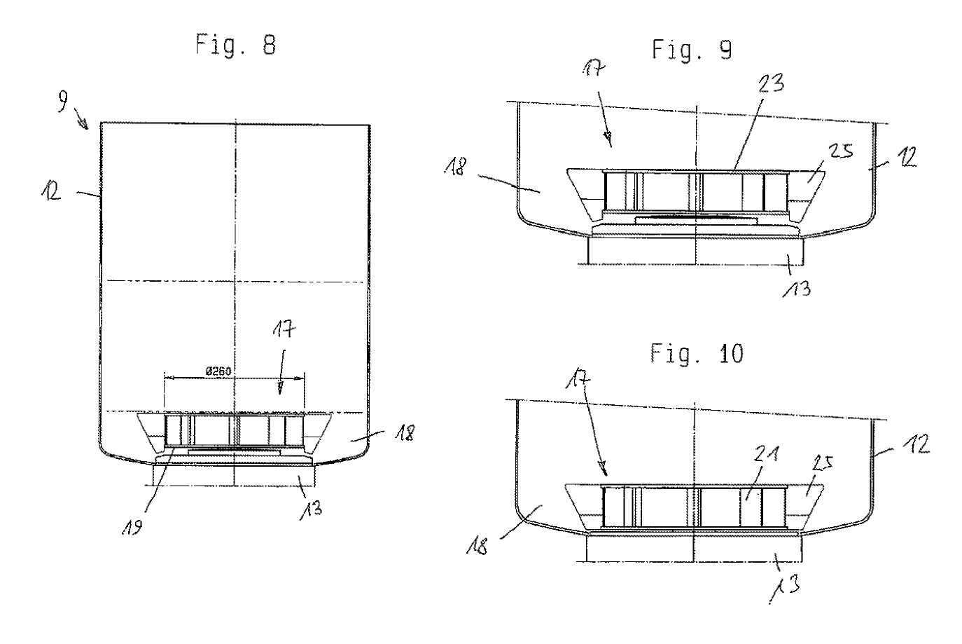

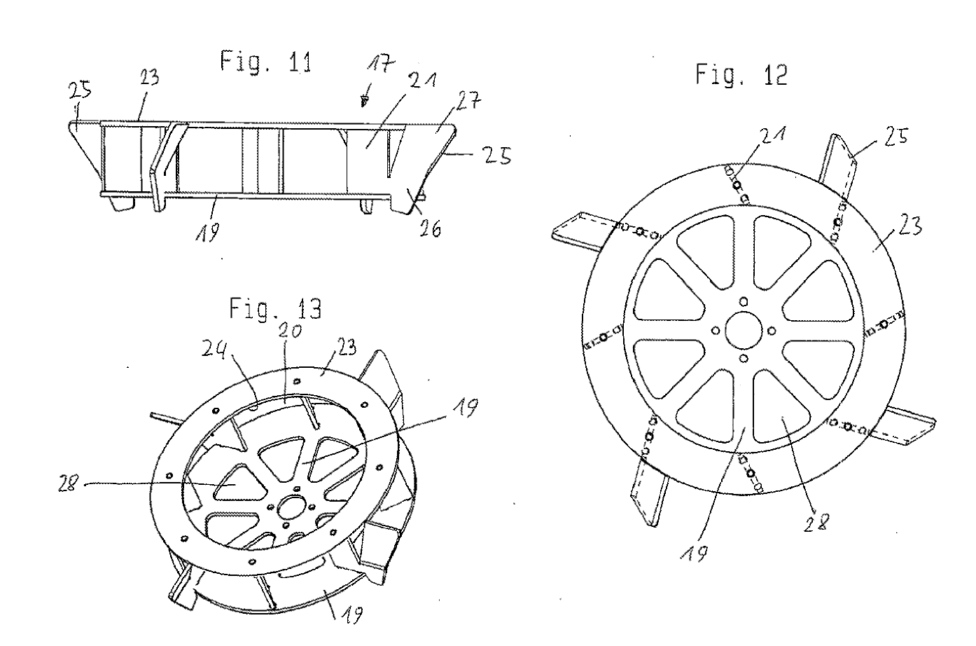

FIGS. 2, 8, 9 and 11 to 13 show an inventive mixing apparatus 9 having an inventive agitator 10.

The mixing apparatus 9 has a stand 11, which stands on the floor. The stand 11 supports an upwardly open, cylindrical mixing container 12, which is disposed in upright position in the upper part of the mixing apparatus 9. A circular plate 13, fastened to the stand 11, forms the bottom of the mixing container 12. The stand 11 supports a single-shaft agitator 14 disposed in the lower part of the mixing apparatus 9. The agitator 14 has a drive motor 15, which is fastened to the stand 11 and has a vertically disposed drive shaft, which, as the agitator shaft 16, projects upward into the mixing container 12. The agitator 14 has just a single agitating tool, disposed in the mixing container 12. This agitating tool is a rotor body 17 fastened to the upper end of the agitator shaft 16. In the mixing container 12, the rotor body 17 is surrounded by an outer, annular free space 18, which is disposed between the rotor body 17 and the cylindrical container wall of the mixing container 12.

The rotor body 17 has a base plate 19 fastened to the agitator shaft 16. Above the base plate 19 is provided an inner free space 20 of the rotor body 17, which free space is disposed above the agitator shaft 16. Around the inner free space 20 are provided mixing blades 21, which are disposed in upright position on the base plate 19. Between the mixing blades 21 are provided flow channels 22, which run outward from the inner free space 20 and are bounded in the upward direction by a cover plate 23 connected to the upper edges of the mixing blades 21. The cover plate 23 contains a centrally arranged recess 24 disposed above the inner free space 20 of the rotor body 17.

In that illustrative embodiment of the rotor body 17 which is represented in FIGS. 2, 8, 9 and 11 to 13, said rotor body has additional mixing blades 25, which protrude outward over the outer edge of the cover plate 23 and protrude into the outer, annular free space 18 disposed between the rotor body 17 and the cylindrical container wall of the mixing container 12. The additional mixing blades 25 have a lower portion 26, running parallel to the rotor rotational axis, and an upper portion 27, running obliquely to the rotor rotational axis. The lower portions 26, running parallel to the rotor rotational axis, of the additional mixing blades 25 protrude downward over the base plate 19 of the rotor body 17.

In that illustrative embodiment of the rotor body 17 which is represented in FIG. 10, the lower portions 26, running parallel to the rotor rotational axis, of the additional mixing blades 25 end on the bottom side of the base plate 19 of the rotor body 17.

In the base plate 19 of the rotor body 17, a plurality of holes or apertures 28 are disposed around the rotor rotational axis. The holes or apertures 28 have an areal extent which is as large as possible. On the one hand, that surface of the base plate 19 of the rotor body 17 which is present for the depositing of mix product residues is thereby kept as small as possible. On the other hand, the relatively large holes or apertures 28 cause the base plate 19 of the rotor body 17 to be flowed around by the mix product.

FIG. 3 shows a further embodiment of an inventive mixing apparatus 29 having an inventive agitator 30.

The mixing apparatus 29 has a stand 31, which stands on the base. The stand 31 supports an upwardly open, cylindrical mixing container 32, which is disposed in upright position in the upper part of the mixing apparatus 29. A circular plate 33, fastened to the stand 31, forms the bottom of the mixing container 32. The stand 31 supports a single-shaft agitator 34 disposed in the lower part of the mixing apparatus 29. The agitator 34 has a drive motor 35, which is fastened to the stand 31 and has a vertically disposed drive shaft, which, as the agitator shaft 36, projects upward into the mixing container 32. The agitator 34 has just a single agitating tool, disposed in the mixing container 32. This agitating tool is a rotor body 37 fastened to the upper end of the agitator shaft 36. In the mixing container 32, the rotor body 37 is surrounded by an outer, annular free space 38, which is disposed between the rotor body 37 and the cylindrical container wall of the mixing container 32.

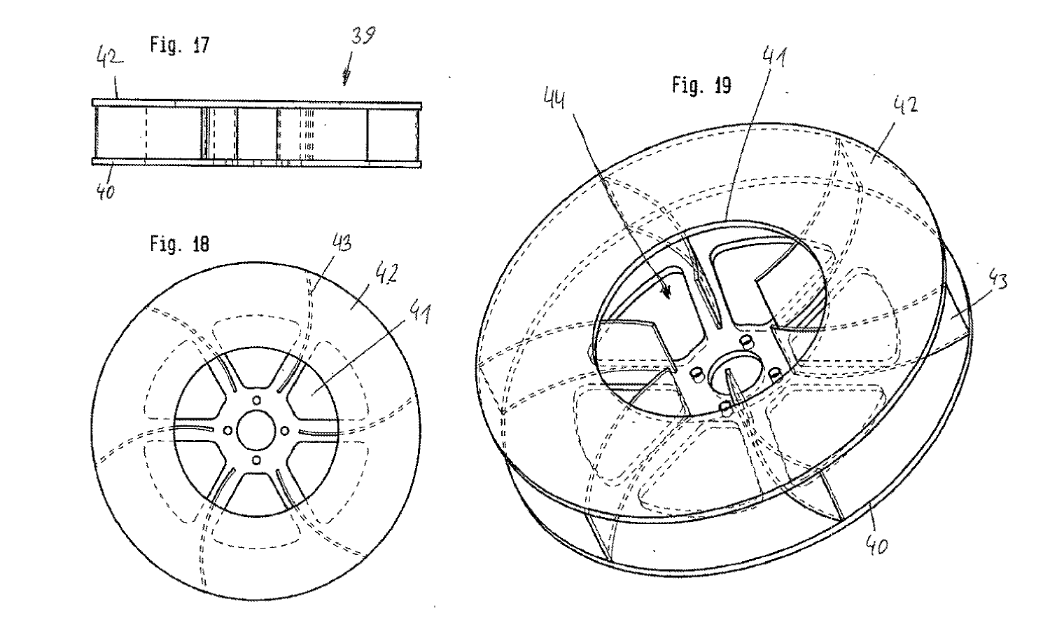

FIGS. 17 to 31 show different embodiments of a rotor body provided for the mixing apparatus 29.

FIGS. 17 to 19 show a rotor body 39, in which, between the base plate 40 and the cover plate 42 provided with a central recess 41, are provided upright mixing blades 43, which with their inner end portions protrude into the inner free space 44 of the rotor body 39. The mixing blades 43 stand on radially running webs configured in the base plate 40. These webs are separated from one another by holes or apertures disposed in the base plate 40. In the base plate 40 are configured six webs, which are arranged in a star shape and on which stand six mixing blades 43 arranged in a star shape. The mixing blades 43 are of curved configuration.

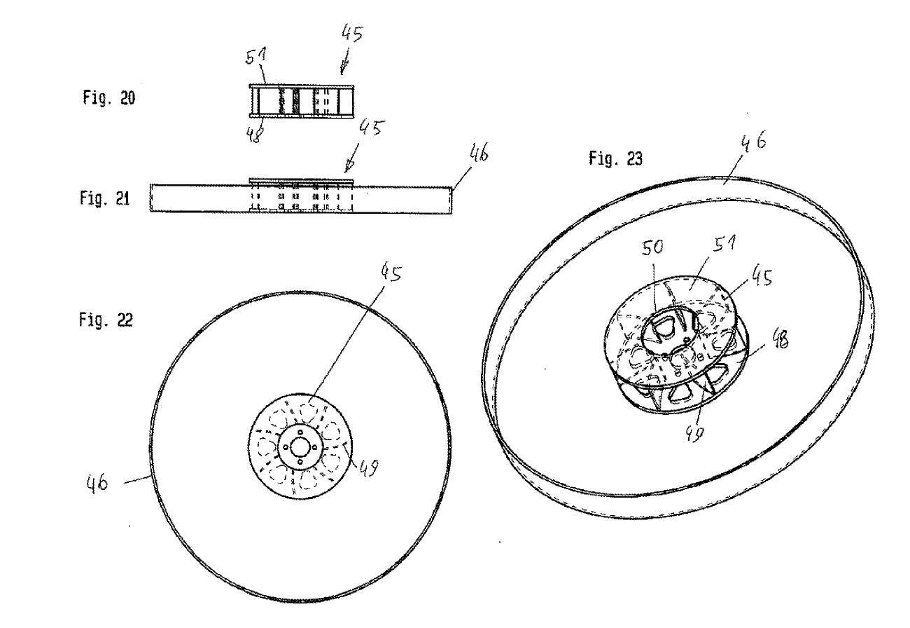

FIG. 20 shows a further rotor body 45. FIGS. 21 to 23 show the rotor body 45 in the lower part of a cylindrical mixing container 46, together with the outer, annular free space 47, which surrounds the rotor body 45 and is disposed between the rotor body 45 and the cylindrical container wall of the mixing container 46. The rotor body 45 has a base plate 48 supporting mixing blades 49, arranged in a star shape, which on the top side are covered by a cover plate 51 provided with a central recess 50. Configured in the base plate 48 are webs, arranged in a star shape, on which the mixing blades 49 stand. Between the webs, recesses are disposed in the base plate 48.

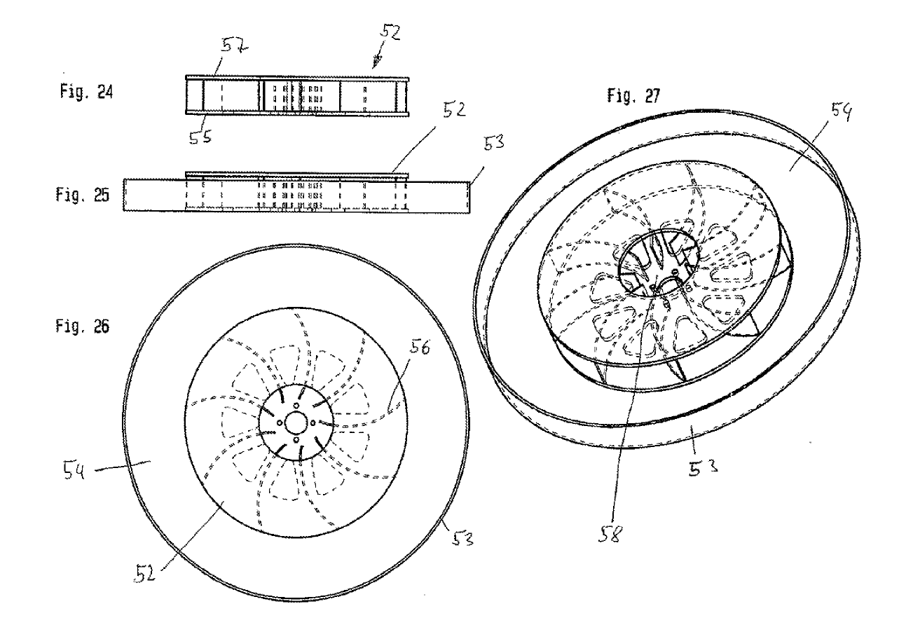

FIG. 24 shows a further rotor body 52. FIGS. 25 to 27 show the rotor body 52 in the lower part of a cylindrical mixing container 53, together with the outer, annular free space 54, which surrounds the rotor body 52 and is disposed between the rotor body 52 and the cylindrical container wall of the mixing container 53. The rotor body 53 has a base plate 55, which supports mixing blades 56, arranged in a star shape, which are covered on the top side by a cover plate 57 provided with a central recess. The mixing blades 56 protrude with their inner end portions into the inner free space 58 of the rotor body 52, which is disposed beneath the central recess of the cover plate 57.

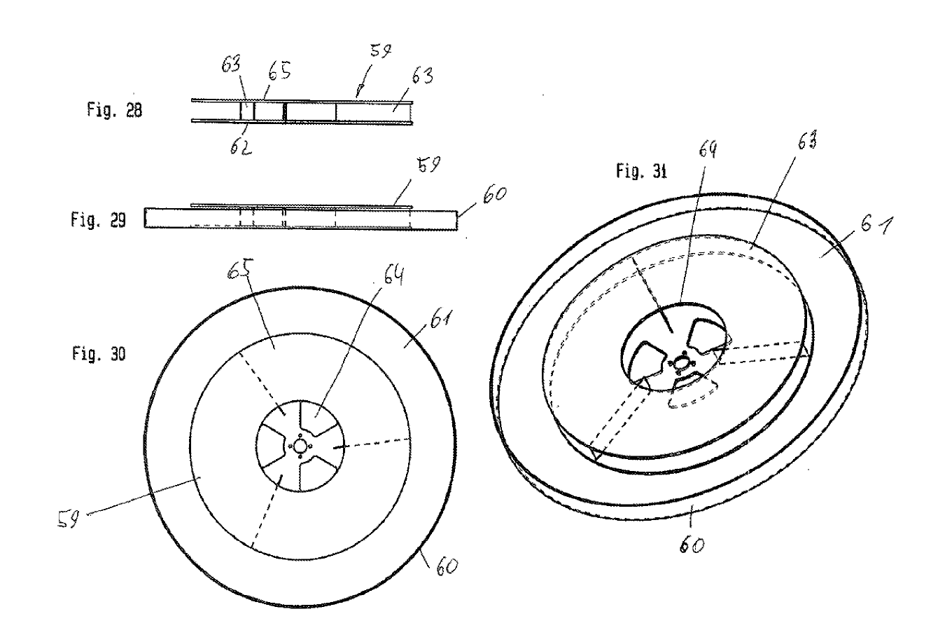

FIG. 28 shows a further rotor body 59. FIGS. 29 to 31 show the rotor body 59 in the lower part of a cylindrical mixing container 60, together with the outer, annular free space 61, which surrounds the rotor body 59 and is disposed between the rotor body 59 and the cylindrical container wall of the mixing container 60. The rotor body 59 has a base plate 62 supporting the three radially running mixing blades 63, arranged in a star shape, which are covered on the top side by a cover plate 65 provided with a central recess 64.

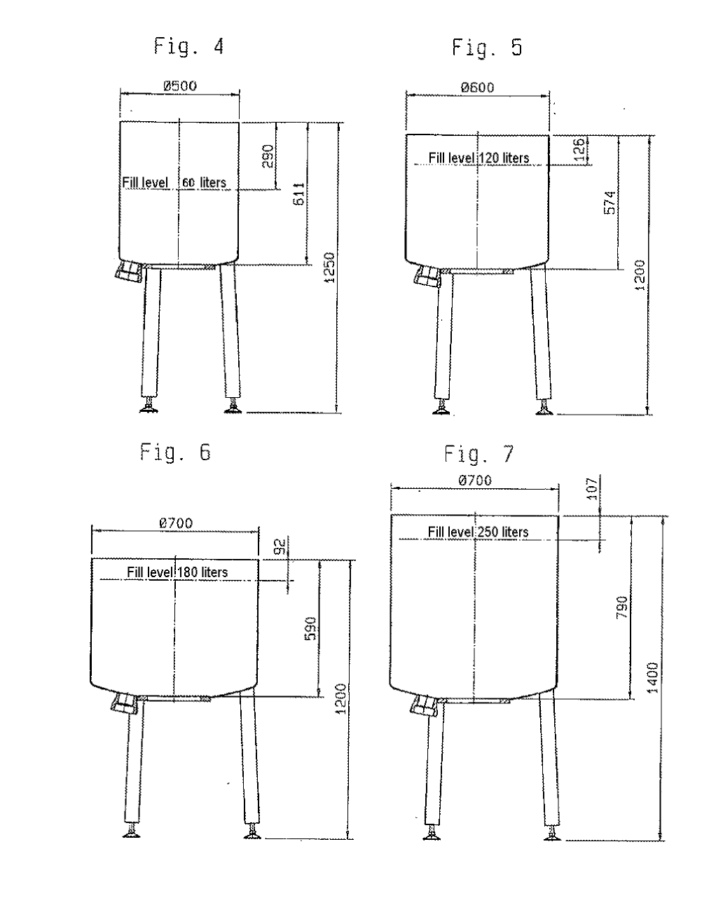

FIGS. 4 to 7 show in schematic representation inventive mixing apparatuses having different-sized mixing containers. For the sake of greater clarity, in FIGS. 4 to 7 only the stand of the mixing apparatus and the upwardly open, cylindrical mixing container disposed in upright position in the upper part of the mixing apparatus are respectively represented. In FIGS. 4 to 7, the size of the mixing container and the associated fill level of the mixing container are respectively indicated.

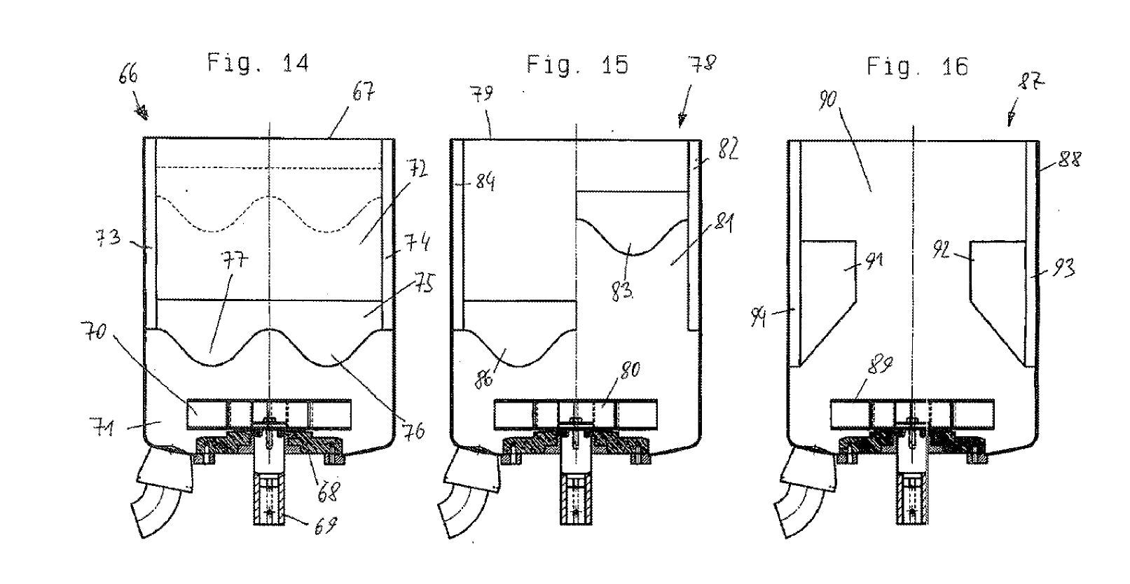

FIG. 14 shows the upper part of an inventive mixing apparatus 66 having an upright, upwardly open, cylindrical mixing container 67, the bottom of which is formed by a circular plate 68 fastened to the stand, which latter is not represented in FIG. 14. In the lower part of the mixing container 67, a rotor body 70, fastened to the agitator shaft 69 of the agitator, is disposed just above the circular plate 68. The rotor body 70 is surrounded by an outer, annular free space 71, which is disposed between the rotor body 70 and the cylindrical container wall of the mixing container 67. In the mixing container 67, a free space 72 for the large flow vortex generated by the rotor body 70 and extending as a mixing spout upward from the rotor body 70 is provided above the rotor body 70. In this free space 72 are provided two diametrically opposing and vertically running rails 73, 74, which are disposed on the cylindrical container wall of the mixing container 67. These rails 73, 74 support a bridge 75 extending transversely through the free space 72. On the bottom side of this bridge 75 are disposed two arc-shaped impact elements 76, 77, which are disposed above the rotor body 70 and reach from above into the mixing spout generated by the rotor body 70. The bridge 75 can be moved up and down along the two rails 73, 74 in order to adjust the position of the impact elements 76, 77 such that they reach from above into the mixing spout.

FIG. 15 shows, analogously to FIG. 14, a further inventive mixing apparatus 78, in which in the upright, upwardly open, cylindrical mixing container 79 is provided a free space 81, which is disposed above the rotor body 80 and in which, at least on a vertical rail 82 disposed on the cylindrical container wall of the mixing container 79, is fitted an impact element 83, which reaches from above into the mixing spout generated by the rotor body 80. In the case of the mixing apparatus 78, two diametrically opposing, vertical rails 82 and 84, respectively supporting an impact element 83 and 86, are provided. The two impact elements 83, 86 have an arc-shaped bottom side and can be vertically adjusted, separately from each other, in the free space 81.

FIG. 16 shows, analogously to FIG. 14 or 15, a further inventive mixing apparatus 87, in which in the upright, cylindrical mixing container 88, above the rotor body 89, is provided a free space 90, in which, above the rotor body 89, are disposed two impact elements 91, 92, which are fitted to lateral, vertical rails 93, 94 disposed on the container wall of the mixing container 88 and are vertically adjustable along these. The two impact elements 91, 92 can be moved vertically up and down along the rails 93, 94 in order to adjust the position of the impact elements 93, 94 to the upper end region of the mixing spout.

1-25. (canceled)

26. A mixing apparatus for producing shapeless masses, the mixing apparatus comprising:
a stand standing upright on a base, an upwardly open, cylindrical mixing container fastened to said stand, said mixing container having a container bottom and a cylindrical container wall;
a statorless single-shaft agitator fastened to said stand and disposed beneath said mixing container;
said agitator having an agitator shaft projecting from below into said mixing container and carrying an agitating tool formed as a rotor body in said mixing container just above said container bottom;
said rotor body forming said agitating tool being surrounded by an annular free space between said rotor body and said cylindrical container wall of said mixing container;
said rotor body having a lower base plate fastened to an upper end of said agitator shaft, mixing blades projecting upward from said base plate, and a cover plate connected to upper edges of said mixing blades;
an inner free space being formed above said base plate and over said agitator shaft, which free space traversing said cover plate in a centrally formed opening; and
said mixing blades in said rotor body being disposed around said inner free space and bounding flow channels running outward from said inner free space and being delimited upwardly by said cover plate of said rotor body.

27. The mixing apparatus according to claim 26, which comprises at least one impact element disposed in a free space in said mixing container above said rotor body, said impact element reaching from above into a mixing spout generated by the rotating rotor body and extending upward from said rotor body.

28. The mixing apparatus according to claim 26, wherein said mixing blades are disposed in said rotor body in a star shape.

29. The mixing apparatus according to claim 28, wherein said mixing blades are curved mixing blades.

30. The mixing apparatus according to claim 28, wherein said mixing blades are radially extending mixing blades.

31. The mixing apparatus according to claim 28, wherein said mixing blades having inner end portions protruding into said inner free space of said rotor body.

32. The mixing apparatus according to claim 31, wherein said mixing blades have outer end portions projecting outwardly over an outer edge of said cover plate and projecting into said annular free space between said rotor body and said cylindrical container wall of said mixing container.

33. The mixing apparatus according to claim 28, wherein said mixing blades have outer end portions projecting outwardly over an outer edge of said cover plate and projecting into said annular free space between said rotor body and said cylindrical container wall of said mixing container.
